(19) United States
(12) Patent Application Publication
(10) Pub. No.: US 2004/0000234 A1
(43) Pub. Date: Jan. 1, 2004

(54) System and method for reducing the chemical reactivity of water and other chemicals used in the fabrication of integrated circuits

(76) Inventors: Axel Preusse, Radebeul (DE); Gerd Marxsen, Radebeul (DE); Johannes Groschopf, Wainsdorf (DE)

Correspondence Address: J. Mike Amerson, Williams , Morgan & Amerson, P.C., Suite 1100, 10333 Richmond, Houston, TX, 77042, US

(21) Appl. No.: 10/306,251

(22) Filed: Nov. 27, 2002

(30) Foreign Application Priority Data
Jun. 28, 2002 (DE) 102 28 997.2

(51) Int. Cl. B01D 19/00

(52) U.S. Cl. 95/263; 95/265; 96/202

(57) ABSTRACT

Methods and systems are provided that allow the reduction of the oxygen concentration and/or a concentration of other natural gases in process liquids used in the processing of substrates, preferably substrates that receive and/or contain exposed metal surfaces, such as copper surfaces. By introducing an inert gas in a water system or in a chemical storage tank for process liquids, already dissolved oxygen will be removed and the further dissolving of oxygen may be substantially prevented. Thus, the probability for the formation of corrosion and discoloration on copper surfaces is significantly reduced.

### BACKGROUND OF THE INVENTION

1. Field of the Invention

The present invention generally relates to the field of fabrication of integrated circuits, and, more particularly, to systems and processes requiring water, for example, in the form of ultra pure water (UPW), for rinsing and cleaning substrates during and after process sequences using chemically reactive materials, such as electrolytes, slurries and the like, employed in the electrochemical treatment of substrates or the chemical mechanical polishing (CMP) of substrates.

2. Description of the Related Art

During the fabrication of integrated circuits, a plurality of different materials have to be deposited on and removed from a substrate, either partially or completely, according to process requirements. Frequently, the deposition and/or removal of materials is performed using wet chemical processes, requiring cleaning the substrate, for example, by rinsing the substrate, prior to, after or during these chemical processes. For contamination concerns, ultra pure water is usually used as a medium for rinsing the substrate.

As critical feature sizes of modern integrated circuits have entered the sub-micron dimension, semiconductor manufacturers are presently replacing the commonly-used aluminum by a metal having a higher conductivity to take account for the reduced size of the metal lines, thus requiring higher electrical and thermal conductivity. In this respect, copper has been proven to be a viable candidate, significantly improving device performance due to copper's superior characteristics in view of conductivity and resistance to electromigration compared to aluminum. Despite the many advantages, copper processing in a semiconductor line also entails many problems requiring new process strategies. Some of these problems are related to chemical surface reactions of metals and, in particular, of copper, in the presence of chemicals, humidity, oxygen and sulfur dioxide. For example, in forming metallization layers of sophisticated integrated circuits, preferably, a so-called damascene process sequence is carried out to form copper metal lines and vias in a dielectric layer. Since copper may not be very efficiently deposited on a substrate with a required thickness in the range of some hundred nanometers to a few micrometers, the plating of copper in the form of electro-plating or electroless plating has become the preferred method of depositing copper. Since a certain amount of excess metal has to be provided during the deposition of copper in order to reliably fill the trenches and vias formed in the dielectric layer, the excess metal has to be subsequently removed. Since, usually, a plurality of metallization layers are formed on top of each other, the surface has to be planarized after each metallization layer, and, therefore, the chemical mechanical polishing of substrates has become a preferred method to remove the excess metal and at the same time planarize the substrate surface.

The chemical mechanical polishing of a substrate usually requires the provision of highly complex slurry-containing abrasives and chemical agents in an aqueous solution to initiate a chemical reaction with the materials to be removed and to subsequently mechanically remove the reaction product. Since the polishing of a surface, including tiny trenches and vias in the presence of two or more materials, typically requires more than one CMP process step, the substrate is usually rinsed between the individual process steps.

It is thus evident that, particularly in the formation of metallization layers, the substrate surface is in contact with various types of chemical agents, such as electrolytes, aggressive ingredients of the slurry, water and the ambient atmosphere. It has been observed that metals, and especially copper, tend to form a high amount of corrosion and discoloration on exposed surfaces during process sequences under “wet” conditions. In turn, this discoloration may lead to a reduced reliability of products and may also adversely affect throughput and process yield.

In view of the above problems, it would be highly desirable to provide methods and apparatus that would allow the processing of substrates receiving or containing sensitive material surfaces, such as copper surfaces, under wet conditions while, at the same time, reducing the probability of the formation of corrosion of the exposed metal surfaces.

### SUMMARY OF THE INVENTION

Generally, the present invention is directed to processes and systems that allow a significant reduction of the probability for a chemical reaction of exposed metal surfaces under wet conditions by reducing the amount of oxygen and/or sulfur dioxide, and/or carbon dioxide, and the like, in water, such as ultra pure water, and other chemicals used in these processes. The term ultra pure water commonly used in the field of semiconductor production is meant to describe de-ionized water that is additionally treated by sterilizing, degassing and removing organic impurities.

According to one illustrative embodiment of the present invention, a method of reducing the formation of corrosion of metal surfaces includes providing a water supply system and introducing an inert gas into the water supply system to substantially prevent oxygen of being dissolved in the water.

According to another illustrative embodiment of the present invention, a method of storing and providing chemicals used in processing metals in a semiconductor production line comprises providing a chemical storage and supply system and introducing an inert gas into the chemical storage and supply system to substantially prevent oxygen of being dissolved in the chemicals.

According to yet another embodiment of the present invention, a water-providing system comprises a water reservoir and a water supply system. Moreover, the water supply system comprises at least one outlet to provide water to a process tool. Furthermore, an inert gas supply system is provided that is connected to at least one of the water reservoir, the water supply system and the at least one outlet to supply an inert gas thereto.

According to still another illustrative embodiment of the present invention, a storage and supply system for chemicals used in processing at least one of metal-containing and metal-receiving substrates comprises a chemical storage tank and a chemical supply system. Moreover, the system comprises a gas supply system to provide an inert gas to at least one of the chemical storage tank and the chemical supply system.

### BRIEF DESCRIPTION OF THE DRAWINGS

The invention may be understood by reference to the following description taken in conjunction with the accompanying drawings, in which like reference numerals identify like elements, and in which:

FIG. 1 shows a Pourbaix diagram of copper;

FIG. 2a schematically shows a system for supplying ultra pure water including an inert gas supply according to one illustrative embodiment of the present invention;

FIG. 2b schematically shows a chemical storage tank including an inert gas supply according to a further illustrative embodiment; and

FIGS. 3a-3b show an outlet of a pure water supply system including a gas supply to provide an inert gas during the discharge of ultra pure water.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

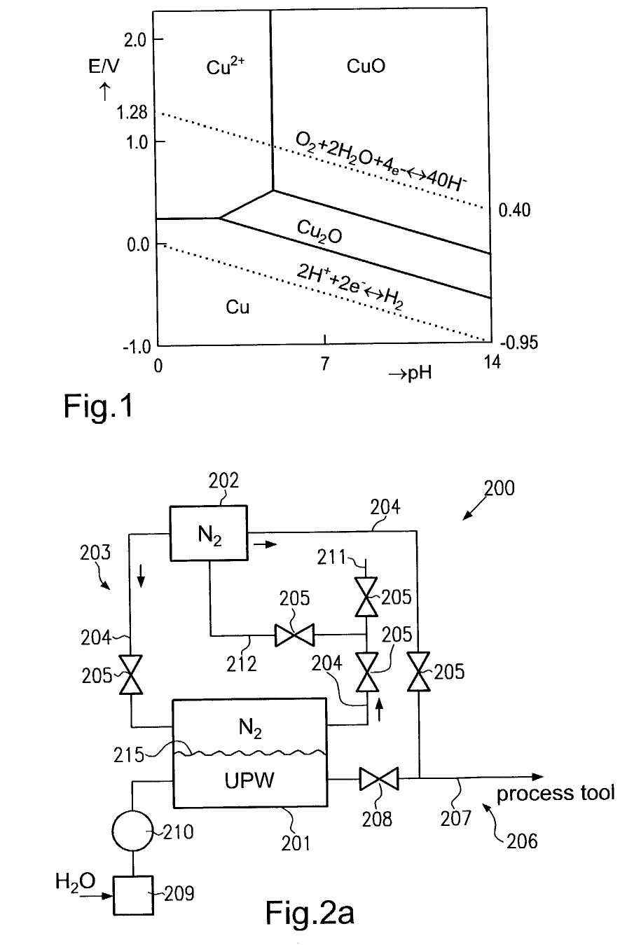

In the following, the chemistry involved in processing metals will be explained in more detail with copper as an exemplary metal, referring to FIG. 1 showing a Pourbaix diagram of copper. However, the present invention should not be considered as limited to use with copper unless such limitations are expressly set forth in the appended claims.

It is well known, that copper is oxidized in air to form copper oxide (Cu₂O). In the presence of carbon dioxide (CO₂), copper may form the so-called green copper carbonate. In the presence of sulfur dioxide (SO₂), which may be present in air, copper may form a sulfate. Therefore, a copper layer on a substrate may most likely be subjected to various oxidation processes creating copper ions (Cu⁺ or Cu⁺⁺) as part of a compound according to the relations given in Equation 1a. These reactions preferably take place in the presence of oxygen and water, which are commonly also present in the ambient air.

O₂+2H₂O+4e⁻→4OH⁻ Equation 1

2Cu→2Cu²⁺+4e⁻ Equation 1a

2H⁺+2e−→H₂. Equation 2

Equation 1 shows the chemical reaction resulting in the so-called oxygen corrosion. The equation shows that oxygen present in air or dissolved in water leads to an oxidation process. The electrons necessary in Equation 1 are spent, for example, by the process of Equation 1a and copper is transformed to Cu²⁺.

FIG. 1 illustrates more clearly this situation in which the so-called Pourbaix diagram of copper is depicted. The Pourbaix diagram shows the electrochemical potentials of copper, its oxides, Cu₂O and CuO, and of the copper ion (Cu⁺⁺) as a function of the pH value. The diagram shows four separate areas denoted as Cu, Cu₂O, CuO and Cu²⁺. The areas are separated by lines representing the situation of equilibrium of the compounds of the neighboring areas. The equilibrium may exist between two compounds along a line in the diagram or between three compounds around an intersection of lines separating different pairs of compounds. The redox potentials of the oxygen reduction according to Equation 1 are also shown in the Pourbaix diagram of FIG. 1. Over the entire pH area, the redox potentials of the oxygen reduction are above the copper equilibrium where Cu₂O and CuO is formed as a protective layer. As a consequence, in the presence of oxygen, according to Equation 1, copper will be oxidized to form copper oxide (CuO) or copper ions (Cu⁺⁺), depending on the pH value.

Another possible situation is demonstrated by Equation 2 and the corresponding electrochemical potential of this equation is also presented in the Pourbaix diagram of FIG. 1. The process according to Equation 2 is generally addressed as hydrogen corrosion, which takes place by reducing 2H⁺ to H₂. As is known from electrochemical potentials, copper is more noble than hydrogen. This fact is represented by the redox function of Equation 2 in the Pourbaix diagram of FIG. 1. Along the entire pH area, the redox potential curve according to Equation 2 is within the area of elementary copper.

It has been demonstrated that, preferably in the presence of oxygen and water, an oxidation processes of copper will take place.

4CuO+SO₂+3H₂O+0,5O₂→CuSO₄.3Cu(OH)₂ Equation 3

Equation 3 shows the formation of caustic copper in the presence of sulfur dioxide (SO₂), water and oxygen. Caustic copper has a good solubility in water. Therefore, the reaction according to Equation 3 removes the copper oxide (CuO) protective layer and may cause further attack of the copper layer. In a similar way, a carbonate of copper may be produced in the presence of humidity, oxygen and carbon dioxide (CO₂).

The present invention is based on the inventors' finding that minimizing the amount of oxygen and other natural gases, such as sulfur dioxide, that may be dissolved in ultra pure water and/or chemicals used in processing substrates, leads to a reduction of corrosion and discoloration on exposed copper surfaces.

The present invention is, therefore, founded on the concept of providing ultra pure water and chemicals to the substrate which contain a significantly reduced amount of oxygen and other natural gases. Providing the ultra pure water with a reduced amount of reactive ambient components may be accomplished by introducing an inert gas into the water supply system and/or providing the ultra pure water in combination with an inert gas stream. Similarly, chemicals used for processing metals, such as copper, may be stored and supplied in an atmosphere that is substantially comprised of an inert gas so that substantially no oxygen or other natural gases are dissolved in the chemicals.

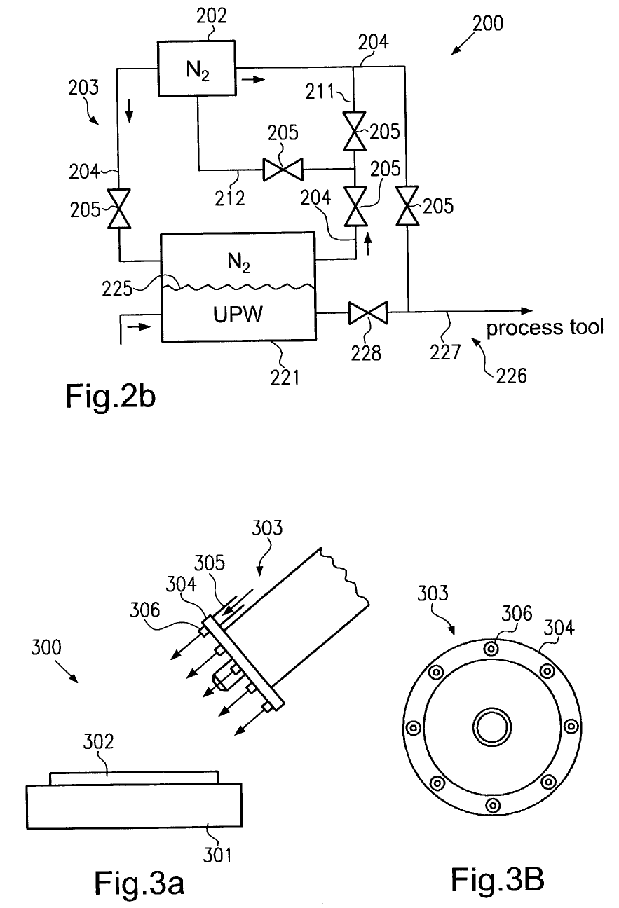

With reference to FIGS. 2a and 2b, illustrative embodiments of the present invention, describing an ultra pure water system and a chemical storage and supply system will now be described.

In FIG. 2a, an ultra pure water system 200 comprises an ultra pure water reservoir 201, an inert gas source 202, and a gas supply system 203 including supply lines 204 and valves 205. The ultra pure water system 200 further comprises a water supply system 206 including one or more supply lines 207 and corresponding valve elements 208. The system 200 may further comprise a water preparation station 209 including a pump system 210. It should be noted that the system 200 is depicted in a very simplified manner to clearly demonstrate the principle of the present invention, wherein further components required for the operation of the system 200, such as pumps, any type of valve elements, and the like which are well known in the art, are not shown. Moreover, the inert gas source 202 may comprise a pressurized gas source, such as a nitrogen source, an argon source, or any other appropriate inert gas, and may additionally or alternatively comprise a chemical reactor that is configured to remove oxygen and/or other gases such as sulfur dioxide from a carrier gas. Such chemical reactors and corresponding catalysts that may be used in some of these reactors are well known in the art and a description thereof will be omitted. Providing a chemical reactor for reworking exhausted nitrogen or other inert gases may be advantageous when large amounts of gases are required or when relatively costly gases are used as the inert gas.

In operation, the water preparation station 209 delivers ultra pure water to the reservoir 201 in which nitrogen is supplied from the inert gas source 202 via one or more of the supply lines 204. Thus, a substantially inert gas atmosphere is established above the water surface 215 in the reservoir 201, so that oxygen and other gases contained in the ambient atmosphere are substantially prevented from being dissolved in the ultra pure water. Moreover, by providing a substantially inert atmosphere above the water surface, any oxygen or other natural gases that may have already been dissolved in the ultra pure water during previous preparation which may have possibly taken place in an open atmosphere will be partially removed from the ultra pure water due to the extremely low partial pressure of these components in the substantially inert gas atmosphere. Thus, the oxygen concentration and/or the sulfur dioxide concentration and/or the concentration of other natural gases may be significantly reduced in the ultra pure water reservoir 201. The ultra pure water may then be delivered to any process tool via the supply line 207. Alternatively, or additionally, other gas supply lines 204 may be coupled to the water supply line 207 to reduce the oxygen concentration of the ultra pure water or to maintain the low oxygen concentration of the ultra pure water discharged from the ultra pure water source 201. The provision of additional gas supply lines 204 for the water supply system 206 is advantageous when a plurality of process tools has to be provided and the ultra pure water has to be conveyed over relatively long distances.

It should be noted that in other embodiments a continuous gas flow may be established in the ultra pure water reservoir 201 by continuously feeding nitrogen thereto and discharging excess nitrogen via an exhaust 211 to reduce the concentration of the reactive ambient components over the liquid surface, thereby also relaxing the concentration of these components in the ultra pure water. Moreover, when a closed gas supply system is used, including, for example, a chemical reactor as previously explained, an exhaust line 212 may be provided to recirculate the discharged nitrogen to the inert gas source 202.

FIG. 2b shows the system 200 wherein a chemical storage tank 221 and chemical supply system 226 may be provided in addition to, or in lieu of, the ultra pure water reservoir 201. The chemical storage tank 221 and the chemical supply system 226 include one or more supply lines 227 and corresponding valve elements 228. Similarly to the system as depicted in FIG. 2a, the chemical storage tank 221 is coupled to the nitrogen gas source 202 by corresponding supply lines 204 and valve elements 205 so as to establish a nitrogen atmosphere over the liquid surface 225 of the chemical agent contained in the chemical storage tank 221. Moreover, the chemical supply system 226 may be coupled to the inert gas source 202 by corresponding supply lines and valves to provide the nitrogen to the supply line 227. The operation and the effect of the system 200, as depicted in FIG. 2b, is quite similar to the system depicted in FIG. 2a, therefore, a description thereof will be omitted.

With reference to FIGS. 3a and 3b, further illustrative embodiments of the present invention will now be described. In FIG. 3a, a process tool 300, which is represented by a substrate holder 301, such as a wafer chuck, having located thereon a substrate 302, comprises a nozzle element 303 configured to supply ultra pure water to the substrate 302. The nozzle element 303 further comprises a gas supply element 304 connected to a gas supply line 305. In the embodiment depicted in FIG. 3, the gas supply element 304 is provided as a substantially ring-shaped element including one or more orifices 306 to provide an inert gas stream simultaneously with the ultra pure water.

FIG. 3b schematically shows a top view of the nozzle element 303 including the gas supply element 304. It should be noted that the nozzle element 303 and, in particular, the gas supply element 304 are only of an illustrative nature and the gas supply element 304 may have any appropriate shape and configuration so long as a flow of inert gas is formed that reduces the degree of contact of the ultra pure water with the ambient atmosphere. The size of the orifices 306 may also vary depending upon the particular application.

As a result, the present invention allows the significant reduction of the concentration of oxygen and/or other natural gases, for example, sulfur dioxide, carbon dioxide, and the like, by supplying an inert gas, such as nitrogen, argon, and the like, to reservoirs of chemicals and water. Alternatively, or additionally, the inert gas may be supplied to the supply lines to “purge” these lines and remove reactive ambient components. Furthermore, the inert gas may be provided immediately prior to or substantially simultaneously with the provision of the water to the process tool, thereby significantly decreasing the probability of corrosion of exposed metal surfaces, in particular of copper surfaces.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of supplying water to a process tool, the method comprising:
providing a water-providing system including a water reservoir, a water supply system and at least one supply line; and
introducing an inert gas into at least one of the water reservoir, the water supply system and the at least one supply line to substantially prevent at least oxygen from being dissolved in the water.

2. The method of claim 1, further comprising establishing a substantially inert gas atmosphere in the water reservoir.

3. The method of claim 1, wherein said inert gas comprises at least one of nitrogen and a noble gas.

4. The method of claim 1, further comprising establishing a continuous flow of inert gas in said water reservoir.

5. The method of claim 1, further comprising providing a nozzle element configured to provide said water to a process tool and providing said inert gas substantially simultaneously with said water from said nozzle element.

6. A method of storing a process chemical, the method comprising:
providing a storage tank for the process chemical, and
introducing an inert gas into said storage tank to substantially prevent at least oxygen from being dissolved in the process chemical.

7. The method of claim 6, further comprising establishing a substantially inert gas atmosphere in the storage tank.

8. The method of claim 6, wherein said inert gas comprises at least one of nitrogen and a noble gas.

9. The method of claim 6, further comprising establishing a continuous flow of inert gas in said storage tank.

10. A system for providing water to a process tool, comprising:
a water reservoir;
a water supply system;
at least one water supply line;
an inert gas source; and
a gas supply system connected to the inert gas source to introduce an inert gas into at least one of the water reservoir, the water supply system and the at least one water supply line.

11. The system of claim 10, wherein said inert gas is at least one of nitrogen and a noble gas.

12. The system of claim 10, wherein said at least one supply line includes a nozzle element including an inlet coupled to said gas supply system.

13. The system of claim 12, wherein said nozzle element comprises a gas supply element coupled to said inlet and comprising at least one orifice configured to produce an inert gas stream substantially simultaneously with a water jet.

14. The system of claim 13, wherein said gas supply element comprises a plurality of orifices arranged at the periphery of said nozzle element.

15. The system of claim 10, wherein said gas supply system is coupled to said at least one water supply line.

16. The system of claim 10, wherein said gas supply system includes an exhaust line connected to the water reservoir to allow the formation of a continuous inert gas flow.

17. A system for storing a process chemical, comprising:
a storage tank configured to store said process chemical;
an inert gas source; and
a gas supply system connected to the inert gas source to introduce an inert gas into said storage tank.

18. The system of claim 17, wherein said gas supply system comprises an exhaust line connected to said storage tank to allow for the formation of a continuous inert gas flow in said storage tank.
